(19) United States
(12) Patent Application Publication
(10) Pub. No.: US 2001/0023647 A1
(43) Pub. Date: Sep. 27, 2001

(54) Sensitised heat sensitive printing plate precursors

(76) Inventor: John Michael Kittridge, Leeds (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/727,815

(22) Filed: Dec. 1, 2000

(30) Foreign Application Priority Data
Dec. 2, 1999 (GB) 9928506.6

(51) Int. Cl. B41N 1/00; B41N 3/00; B41N 3/03; B41N 3/04; B41N 3/08

(52) U.S. Cl. 101/458; 101/453

(57) ABSTRACT

A lithographic printing plate precursor comprises a grained and anodised aluminium substrate coated with a metallic layer, preferably a silver layer, on top of which is applied a layer comprising at least one sensitising material which adsorbs on to the metallic surface and thereby sensitises the system to heat mode laser exposure. Preferably, the sensitising material comprises a material which includes at least one sulphur, selenium or tellurium containing group and the sensitising layer additionally comprises a hydrophilic material. The invention provides lithographic printing plate precursors having high sensitivity which may be imagewise exposed by means of a high intensity laser beam to provide press ready plates showing high image quality, good press properties and high durability on press without the requirement for the use of intermediate film and developer chemistry.

This invention relates to the formation of images directly from electronically composed digital sources and is particularly concerned with the formation of images on lithographic printing plate precursors. More particularly, the invention relates to lithographic printing plate precursors which incorporate an imaging layer comprising metallic silver, and a method of preparing lithographic printing plates which does not require the use of chemical treatments.

Lithographic printing is a process of printing from surfaces which have been prepared in such a way that certain areas are capable of accepting ink (oleophilic areas), whereas other areas will not accept ink (oleophobic areas). The oleophilic areas form the printing areas while the oleophobic areas form the background areas.

Plates for use in lithographic printing processes may be prepared using a photographic material that is made imagewise receptive or repellent to ink upon photo-exposure of the photographic material and subsequent chemical treatment. However, this method of preparation, which is based on photographic processing techniques, involves several steps, and therefore requires a considerable amount of time, effort and expense.

Consequently it has, for many years, been a long term aim in the printing industry to form images directly from an electronically composed digital database, ie by a so-called “computer-to-plate” system. The advantages of such a system over the traditional methods of making printing plates are:

(i) the elimination of costly intermediate silver film and processing chemicals;

(ii) a saving of time; and

(iii) the ability to automate the system with consequent reduction in labour costs.

The introduction of laser technology provided the first opportunity to form an image directly on a printing plate precursor by scanning a laser beam across the surface of the precursor and modulating the beam so as to effectively turn it on and off. In this way, radiation sensitive plates comprising a high sensitivity polymer coating have been exposed to laser beams produced by water cooled UV argon-ion lasers and electrophotographic plates having sensitivities stretching into the visible spectral region have been successfully exposed using low powered air-cooled argon-ion, helium-neon and semiconductor laser devices.

Imaging systems are also available which involve a sandwich structure which, on exposure to a heat generating infra-red laser beam, undergoes selective (imagewise) delamination and subsequent transfer of materials. Such so-called peel-apart systems are generally used as replacements for silver halide films.

A digital imaging technique has been described in U.S. Pat. No. 4,911,075 whereby a so-called driographic plate which does not require dampening with an aqueous fountain solution to wet the non-image areas during printing is produced by means of a spark discharge. In this case, a plate precursor comprising an ink-repellent coating containing electrically conductive particles coated on a conductive substrate is used and the coating is ablatively removed from the substrate. Unfortunately, however, the ablative spark discharge provides images having relatively poor resolution.

It is known to improve this feature by the use of lasers to obtain high resolution ablation as described, for example, by P E Dyer in “Laser Ablation of Polymers” (Chapter 14 of “Photochemical Processing of Electronic Materials”. Academic Press, 1992, p359-385). Until recently, imaging via this method generally involved the use of high power carbon dioxide or excimer lasers. Unfortunately, such lasers are not well-suited to printing applications because of their high power consumption and excessive cost, and the requirement for high pressure gas handling systems. Recent developments have, however, led to the availability of more suitable infra-red diode lasers, which are compact, highly efficient and very economical solid state devices. High power versions of such lasers, which are capable of delivering up to 3000 mJ/cm², are now commercially available.

Coatings which may be imaged by means of ablation with infra-red radiation have previously been proposed. Thus, for example, a proofing film in which an image is formed by imagewise ablation of a coloured layer on to a receiver sheet is described in PCT Application No 90/12342. This system is, however, disadvantageous in requiring a physical transfer of material in the imaging step, and such methods tend to give rise to inferior image resolution.

Much superior resolution is obtained by means of the ablation technique described in European Patent No 649374, wherein a driographic printing plate precursor is imaged digitally by means of an infra-red diode laser or a YAG laser, and the image is formed directly through the elimination of unwanted material. The technique involves exposing a plate precursor, incorporating an infra-red radiation ablatable coating covered with a transparent cover sheet, by directing the beam from an infra-red laser at sequential areas of the coating so that the coating ablates and loses its ink repellancy in those areas to form an image, removing the cover sheet and ablation products, and inking the image.

A heat mode recording material is disclosed in U.S. Pat. No. 4,034,183 which comprises an anodised aluminium support coated with a hydrophilic layer. On imagewise exposure using a laser, the exposed areas are rendered hydrophobic, and thereby accept ink.

Japanese patent application laid open to public inspection No 49-117102 (1974) discloses a method for producing printing plates wherein a metal is incorporated in the imaging layer of a printing plate precursor which is imaged by irradiation with a laser beam modulated by electric signals. Typically, the plate precursor comprises a metal base, such as aluminium, coated with a resin film, which is typically nitrocellulose, and on top of which has been provided a thin layer of copper. The resin and metal layers are removed in the laser-struck areas, thereby producing a printing plate. The disadvantage of this system, however, is that two types of laser beam irradiation are required in order to remove firstly the copper (eg by means of an argon-ion laser) and then the resin (eg with a carbon dioxide laser); hence, the necessary equipment is expensive.

Subsequently a method of printing plate production which obviated the requirement for a second laser exposure was disclosed in Japanese patent application laid open to public inspection No 52-37104 (1977). Thus, a printing plate precursor comprising a support, typically aluminium, an anodic aluminium oxide layer, and a layer of brass, silver, graphite or, preferably, copper is exposed to a laser beam of high energy density in order to render the exposed areas hydrophilic to yield a printing plate. The printing plate precursor is, however, of rather low sensitivity and requires the use of a high energy laser for exposure.

An alternative heat mode recording material for making a lithographic printing plate is disclosed in European Patent No 609941, which comprises a support having a hydrophilic surface, or provided with a hydrophilic layer, on which is coated a metallic layer, on top of which is a hydrophobic layer having a thickness of less than 50 nm. A lithographic printing plate may be produced from the said material by imagewise exposing to actinic radiation, thereby rendering the exposed areas hydrophilic and repellent to greasy ink.

Conversely, European Patent No 628409 discloses a heat mode recording material for making a lithographic printing plate which comprises a support and a metallic layer, on top of which is provided a hydrophilic layer having a thickness of less than 50 nm. A lithographic printing plate is produced by imagewise exposing the material to actinic radiation in order to render the exposed areas hydrophobic and receptive to greasy ink.

In each of the two foregoing heat mode recording materials, however, difficulties in printing will be encountered. On exposure of the materials to actinic radiation, the energy is converted to heat in the image areas by interaction with the metallic layer, thereby destroying the hydrophilicity or hydrophobicity—depending on the material employed—of the topmost layer in those areas. Consequently, the surface of the metallic layer becomes exposed, and the success of the printing operation is dependent upon differences in hydrophilicity and oleophilicity between the metallic surface and the hydrophilic or hydrophobic layer, as the case may be. Since the metallic layer functions as the hydrophobic surface in one case, and as the hydrophilic surface in the alternative case, it would be expected that such differences in hydrophilicity and oleophilicity would not be sufficiently clearly defined so as to provide a satisfactory printing surface. Furthermore, when a hydrophilic layer is present, and the metallic surface functions as the oleophilic areas of the plate, image areas will necessarily be printed from the metallic surface; such an arrangement is known to be unsatisfactory, and to result in difficulties in achieving acceptable printing quality.

Subsequently, a series of PCT patent applications (WO 98/55307-WO 98/55311 and WO 98/55330-WO 98/55332) has disclosed heat mode recording materials comprising a grained and anodised aluminium substrate and an ablatable metallic layer, said materials providing lithographic printing plates showing high image quality and excellent printing properties. Also described are imaging methods for the preparation of the said printing plates, these methods relying on direct-to-plate exposure techniques and thereby obviating the requirement for the use of costly intermediate film or processing developers after exposure.

Individual specifications within this series of patent applications also disclose various distinct additional features such as the inclusion of an further layer on top of the metallic layer; for example, WO 98/55311 teaches the presence of a transparent cover sheet or layer of material to collect ablated debris, whereas WO98/55308 describes a hydrophobising layer comprising a proteolytic enzyme and an oleophilising agent, this layer improving the ink-accepting properties of image areas and thereby increasing the degree of differentiation between hydrophilic and oleophilic areas.

Lithographic printing plate precursors of this type do, however, suffer from the disadvantage that the exposure times which are required in order to achieve efficient ablation of the metallic layer and image formation are relatively lengthy and fairly high amounts of energy are consumed. Clearly, the commercial viability of such a process would be greatly enhanced if the sensitivity of the plate precursor could be increased such that the said exposure times and quantities of energy might be reduced to some significant extent. Consequently, it is the primary objective of the present invention to provide a lithographic printing plate precursor in which ablation of a metallic layer in non-image areas may be achieved with lower energy levels.

The present inventors have found that increased sensitivity of a radiation sensitive lithographic printing plate precursor to heat mode laser exposure may surprisingly be achieved by formulating said precursor by deposition of a metallic layer on a hydrophilic substrate and subsequent overcoating of the metallic layer with a layer which includes a material which adsorbs on to the metallic layer, the said material acting as a sensitiser for the radiation sensitive precursor.

Thus, according to a first aspect of the present invention there is provided a lithographic printing plate precursor comprising:

(a) a grained and anodised aluminium substrate, having provided thereon

(b) a metallic layer, on top of which is applied

(c) a layer comprising at least one sensitising material which adsorbs on to the metallic surface and thereby sensitises the system to heat mode laser exposure.

The substrate employed in the present invention is an aluminium substrate which has been electrochemically grained and anodised on at least one surface in order to enhance its lithographic properties. Optionally, the aluminium may be laminated to other materials, such as paper or various plastics materials, in order to enhance its flexibility, whilst retaining the good dimensional stability associated with aluminium.

The metallic layer, which is applied to the grained and anodised surface of the aluminium, may comprise one or a combination of several metals, specific examples of which include copper, bismuth and brass. Most preferably, however, the metallic layer comprises a silver layer. The thickness of the metallic layer is preferably from 1 nm to 100 nm, most preferably from 10 nm to 50 nm.

Various techniques are available for the application of the metallic layer to the grained and anodised aluminium substrate, including vapour or vacuum deposition or sputtering. In the case where the metal layer comprises a silver layer, however, the most preferred method for applying the layer involves the treatment of a silver halide material according to the silver salt diffusion transfer process.

In the diffusion transfer process, a silver halide emulsion layer is transformed by treatment with a so-called silver halide solvent, into soluble silver complex compounds which are then allowed to diffuse into an image receiving layer and are reduced therein by means of a developing agent, generally in the presence of physical development nuclei, to form a metallic silver layer.

Two such systems are available: a two sheet system in which a silver halide emulsion layer is provided on one element, and a physical development nuclei layer is provided on a second element, the two elements are placed in contact in the presence of developing agent(s) and silver halide solvent(s) in the presence of an alkaline processing liquid, and subsequently peeled apart to provide a metallic silver layer on the second element; and a single sheet system wherein the element is provided with a physical development nuclei layer, a silver halide emulsion layer is provided on top thereof, the element is treated with developing agent(s) and silver halide solvent(s) in the presence of an alkaline processing liquid, and the element is washed to remove spent emulsion layer and leave a metallic silver layer which is formed in the layer containing physical development nuclei.

Alternatively, the diffusion transfer process may be used to apply a metallic silver layer by overall exposing a positive working silver halide emulsion layer to form a latent negative image which is then developed in contact with a physical development nuclei layer to form a metallic silver layer. Again, the process may be carried out using either a single sheet or a double sheet system.

The principles of the silver complex diffusion transfer process are fully described in the publication “Photographic Silver Halide Diffusion Processes” by Andre Rott and Edith Weyde, The Focal Press, London and New York, 1972, and further detail may be gleaned by reference thereto.

The layer which is applied over the metallic layer includes at least one sensitising material which adsorbs on to the metallic surface and provides increased sensitivity to heat mode laser exposure. Various materials are known to adsorb on to metallic surfaces and several of these have been found to provide such an increase in sensitivity. Specifically, in those cases wherein the metallic layer comprises a silver layer, significant sensitivity improvements have resulted from the application of layers comprising materials which include at least one sulphur, selenium or tellurium containing group. In particular, suitable groups include thiol groups, substituted thio groups which are readily hydrolysed to provide thiol groups, disulphide groups, thioacid groups, thioarnide groups and isothiocyanate groups, together with the selenium and tellurium analogues of the foregoing. In addition, improvements in sensitivity have resulted from the incorporation of cationic materials, in particular cationic surfactants or cationic dyes, in the topmost layer of such a lithographic printing plate precursor.

Particular examples of sensitising materials which are suitable for incorporation in the topmost layer of the lithographic printing plate precursors of the present invention include the following:

1. Thiol derivatives such as dodecylmercaptan, 1-methyl-5-mercaptotetrazole, 1-phenyl-5-mercaptotetrazole, sodium 1-octyl-5-mercaptotetrazole, n-heptyl-2-mercapto-1,3,4-oxadiazole, 2-mercaptobenzothiazole, 1,4-dithioerythritol, thiosalicylic acid, mercaptosuccinic acid potassium salt, 2-mercaptobenzoxazole, 2-mercaptobenzimidazole and 3-mercapto-4-methyl-4H-1,2,4-triazole.

2. Hydrolysable thio compounds such as S-diethylaminoethyl isothiuronium chloride hydrochloride.

3. Disulphide compounds such as tetramethylthiuram disulphide, cystine and 2,2′-dithiobenzoic acid.

4. Thioacids such as thiobenzoic acid and their salts including, for example, potassium ethyl xanthate and sodium diethyldithiocarbamate.

5. Thioamides such as thiourea, allylthiourea, thiosemicarbazide, dithizone, dithiooxamide and 2-thiobarbituric acid.

6. Isothiocyanates such as phenyl isothiocyanate.

7. Selenium and tellurium analogues of the foregoing thio compounds such as 2-selenylbenzothiazole and selenourea.

8. Cationic surfactants such as benzyldimethyltetradecylammonium chloride, cetylpyridinium iodide, di-dodecyldimethylammonium chloride, (diisobutylphenoxyethyl)dimethylbenzylammonium chloride, trioctylmethylarnmonium chloride, octadecyltrimethylanrnonium bromide, methylpolyoxyethylene(15)cocoammonium chloride, dimethyloctadecylsulphonium-p-toluene sulphonate and Zonyl FSD (a fluorinated cationic surfactant supplied by E I du Pont de Nemours & Co.)

9. Cationic dyes such as Methylene Blue, Brilliant Green, Phenosafranine, Pinacryptol Yellow and Crystal Violet.

Preferably, the topmost layer additionally includes a hydrophilic material which, in addition to serving as a binder for the sensitising material, can act as an ink desensitiser for the anodised aluminium surface revealed after imagewise ablation of the overlying metallic layer, ultimately rendering said aluminium surface more hydrophilic, and hence reducing unwanted take-up of ink in the background, non-image, areas. During conventional platemaking operations, such desensitising agents are generally applied to a plate surface following imagewise exposure and, when appropriate, development.

However, the presence of said hydrophilic materials prior to exposure obviates the requirement for such post-exposure treatments and facilitates direct-to-press application of the printing plate. Thus, the plate may be directly transferred to a printing press following exposure, without the requirement for any intermediate treatment, since the hydrophilic materials are readily removable from the silver image in printing areas by means of aqueous washing; such washing is effectively achieved by the action of the typical aqueous fount solutions and fount-ink mixtures commonly used on printing presses, and the hydrophilic material is thereby replaced by a film of ink in image areas and fount in background, non-image areas. An alternative means of direct to press exposure is also possible, wherein the plate precursor is exposed in situ on a printing press.

Virtually any of the hydrophilic materials commonly used as desensitising agents for background areas of lithographic printing plates during printing operations may be used for present purposes, but specific examples include sodium hexametaphosphate, sodium gluconate, dextrin, gum arabic and sorbitol.

The present invention also effectively provides a method by which the radiation sensitivity of lithographic printing plate precursors comprising a substrate and a metallic layer may be further improved. Thus, according to a second aspect of the present invention, there is provided a method for improving the sensitivity to heat mode laser exposure of a non-sensitised lithographic printing plate precursor, the said method comprising:

(a) providing a non-sensitised lithographic printing plate precursor comprising a grained and anodised alurninium substrate having provided thereon a metallic layer; and

(b) applying, on the metallic layer, a layer comprising a sensitising material which adsorbs on to the metallic surface and thereby sensitises the system to heat mode laser exposure.

The topmost layer may be applied from aqueous or organic solvent solution using any suitable coating technique selected from those well known in the art such as, for example, dip coating, gravure coating, spray coating, slot coating or reverse roll coating. The layer may solely comprise the sensitising material which is adsorbed on the metallic surface but, preferably, additionally includes further materials chosen from wetting agents, dispersing agents, biocides, buffers, dyes, or other materials which may enhance the press performance of the final printing plate, in addition to the hydrophilic materials previously discussed. Preferably, the sensitising material is present in the layer to the extent of between 5 and 50%.

The coating solution should preferably have a pH of between 3 and 10, since damage to the metallic layer may result from a coating solution having a pH which is either too high or too low. It is also advantageous to avoid the presence of oxidising agents in the coating solution. Iodide salts, for example, may interact with organic materials to liberate free iodine which can then react with the metallic layer, thereby destroying the effectiveness of the radiation sensitive system. As a precaution against such eventualities, it is often prudent to incorporate suitable reducing agents, such as ascorbic acid, in the top layer.

The sensitising material may be present as a monolayer, or it may be applied together with the other materials previously specified to give a dry coating weight of up to 10 g/m². In any event, said sensitising material should be present in an amount sufficient to provide at least a monolayer on the plate surface. Thus, in the absence of other materials, the sensitising material should be present at a coating thickness of between a monolayer and 0.5 μm, preferably between 0.01 and 0.1 μm. When other materials are present in the top layer, this should be applied to give a dry coating weight of between 0.01 and 10 g/m², preferably between 0.05 and 0.5 g/m². Any additional components of the said layer should, after exposure, be readily removed from the surface of the metallic layer by simple aqueous washing in order to facilitate rapid ink acceptance in image areas, thereby ensuring that the plate has good roll-up properties.

According to a third aspect of the present invention, there is provided a method of preparing a lithographic printing plate, said method comprising:

(a) providing a lithographic printing plate precursor as hereinbefore described; and

(b) imagewise exposing said precursor by means of a heat mode laser beam.

The lithographic printing plate precursor is imaged by a beam of radiation, preferably from a laser operating in the infra-red region of the spectrum. Examples of suitable infra-red lasers include semiconductor lasers and YAG lasers, for example the Gerber Crescent 42T Platesetter with a 10 W YAG laser outputting at 1064 nm. Exposure to the beam of radiation causes ablation of the metallic layer to occur in the radiation-struck areas. Additionally, the metallic layer may be exposed to lasers providing radiation of other wavelengths, such that a heating effect—which leads to ablation—is produced. A suitable example is a KrF laser outputting at 248 nm and generating power density of 3 MW/cm².

Said exposure may be carried out with the printing plate precursor mounted on a printing press or, in the alternative, using a separate exposure station. In the latter case, following imagewise exposure, the resulting plate may be directly mounted on a printing press; in either event, removal of the top layer, together with any silver particles remaining in exposed areas, occurs either as a result of the action of the press fount solutions, or other start-up chemicals, on the plate surface, or during the course of other procedures involved in the printing operation. In such cases of exposure on press or direct transfer from exposure station to press, it is desirable that at least one of the adsorbed sensitising materials in the top layer should additionally be able to confer increased oleophilicity on the metallic layer, thus ensuring good ink acceptance in the image areas.

Alternatively, after exposure, the plate may be subjected to a manual or automatic scrubbing and/or soaking treatment with an aqueous solution in order to remove the top layer; this procedure, which is described in PCT patent application no. WO 98/55309, additionally facilitates removal of any silver particles remaining in exposed areas, and enables the cosmetic appearance of the plate to be improved prior to press operations. Following, or concurrent with, this cleaning step, the plate is prepared for printing operations by treatment with an aqueous composition comprising at least one oleophilising agent for the image areas and at least one compound capable of desensitising the non-image areas to ink. In this way, it is possible to ensure good ink acceptance in image areas and a high degree of hydrophilicity in background areas, thus enabling a good start-up on press to be achieved.

Suitable oleophilising agents for use in the above composition may be chosen from those disclosed on pages 105 to 106 of “Photographic Silver Halide Diffusion Processes” by Andre Rott and Edith Weyde, but mercapto compounds and cationic surfactants such as quaternary ammonium compounds are of particular value. Examples of compounds useful for desensitising non-image areas include carbohydrates such as gum arabic and dextrin, inorganic polyphosphates such as sodium hexametaphosphate, alcohols, glycols and anionic and non-ionic surfactants. Advantageously, the compositions may also incorporate enzymes such as trypsin, pepsin, ficin, papain or the bacterial proteases or proteinases

Typically, the said compositions comprise aqueous solutions containing from 0.05% to 5.0% by weight of oleophilising agent, from 1.0% to 10.0% by weight of desensitising compound, and from 0% to 10.0% by weight of enzyme.

The present invention provides lithographic printing plate precursors having high radiation sensitivity which may be used according to the method of the third aspect of the present invention to provide press ready plates showing high image quality, good press properties and high durability on press without the requirement for the use of costly intermediate film and developer chemistry and the attendant inconvenience resulting from the use of these materials.

The following examples are illustrative of the invention, without placing any limit on the scope thereof:

### EXAMPLES

### Example 1

Samples of a commercially available Howson SLVERLITH® SDB printing plate, available from Agfa-Gevaert Ltd., were processed without exposure through an automatic processor by means of the diffusion transfer reversal method, in accordance with the recommendation of the manufacturer, but a bacterial protease enzyme was added to the water washing stage, and the final stage of applying a specified finishing gum was omitted. The resulting samples of printing plate precursor comprised a grained and anodised aluminium substrate, on the anodised surface of which was a coated layer of silver at a coat weight of 0.5 g/m².

The plate samples were whirler coated with a solution containing sensitising material and 0.2% w/v polyvinylpyrrolidone (molecular weight 700,000) as binder in a solvent mixture comprising water, isopropanol and methyl ethyl ketone. Various sensitising materials were employed, as detailed in Table 1. Following whirler coating, the samples were dried at 60° C. for 2 minutes to give a dry top coat weight of 0.3 g/M².

The samples were then loaded onto a Gerber Crescent 42T internal drum Laser Platesetter and imagewise exposed to a 10 W YAG laser outputting at a wavelength of 1064 nm. The correct exposure for each sample was that which resulted in the most accurate reproduction of a 50% dot tint. The maximum available exposure on the Gerber 42T Platesetter is 255 units; consequently an exposure requirement below that value was indicative of a faster, more sensitive plate. The results of the evaluation are shown in Table 1.

TABLE 1

| | | Sensitivity |
|---|---|---|
| Sample | Sensitising material in top coat solution | (units) |
| 1 | No overcoat | 235 |
| 2 | None | 235 |
| 3 | 0.4% Glycerol | 240 |
| 4 | 0.2% Triton X-100 (non-ionic surfactant) | 225 |
| 5 | 0.1% Cetylpyridinium chloride | 205 |
| 6 | 0.2% Cetylpyridinium chloride | 200 |
| 7 | 0.4% Cetylpyridinium chloride | 195 |
| 8 | 0.2% Cetylpyridinium chloride + 0.2% Potassium | 195 |
| | iodide | |
| 9 | 0.2% Benzyldimethyltetradecylammonium chloride | 210 |
| 10 | 0.4% Trioctylmethylammonium chloride | 195 |
| 11 | 0.2% 1-Methyl-5-mercaptotetrazole | 190 |
| 12 | 0.2% Sodium 1-octyl-5-mercaptotetrazole + 0.2% | 205 |
| | Citric acid | |
| 13 | 0.2% Sodium 1-octyl-5-mercaptotetrazole + 0.2% | 205 |
| | Dowfax 2A1 (anionic surfactant) | |
| 14 | 0.2% Dodecylmercaptan | 210 |
| 15 | 0.2% Octadecylmercaptan | 210 |
| 16 | 0.2% Allylthiourea | 205 |
| 17 | 0.2% n-Heptyl-2-mercapto-1,3,4-oxadiazole | 205 |
| 18 | 0.2% Thiosalicylic acid potassium salt | 205 |
| 19 | 0.2% n-Heptyl-2-mercapto-1,3,4-oxadiazole + 0.2% | 205 |
| | Cetyl pyridinium chloride | |

### TABLE 1

### Example 2

Samples of lithographic printing plate precursor having a silver coat weight of 0.5 g/m² were produced as detailed in Example 1. Top coats were then applied to the samples in accordance with the following details:

Sample A (Control)

A sample of plate precursor was roller coated with a solution containing

| | | |
|---|---|---|
| Sodium hexametaphosphate | 50 | g |
| Triethanolamine | 20 | ml |
| Sodium gluconate | 90 | g |
| Lutensit APS (anionic surfactant) | 30 | ml |
| Polyethyleneglycol 200 | 60 | ml |
| Citric Acid | 3.3 | g |
| Alcalase (bacterial protease) | 25 | ml |
| Water | to 1 | liter |

to give a dry top coat weight of 0.1 g/m²

Sample B

A sample of plate precursor was roller coated with a solution containing

| | | |
|---|---|---|
| Sodium hexametaphosphate | 50 | g |
| Triethanolamine | 25 | ml |
| Sodium gluconate | 50 | g |
| Lutensit APS (anionic surfactant) | 43 | ml |
| Sorbitol | 50 | g |
| Citric Acid | 5.2 | g |
| Sodium 1-octyl-5-mercaptotetrazole | 2.0 | g |
| Alcalase (bacterial protease) | 25 | ml |
| Water | to 1 | liter |

to give a dry top coat weight of 0.1 g/m².

Sample C

A sample of plate precursor was whirler coated with a solution containing 0.4% w/v cetylpyridinium chloride and 0.4% w/v polyvinylpyrrolidone in a solvent mixture of 80/20 v/v isopropanol/methyl ethyl ketone and dried for 2 minutes at 60° C. to give a dry top coat weight of 0.4 g/m².

Sample D

A sample of plate precursor was whirler coated with a solution containing 0.4% w/v benzyldimethyltetradecylammonium chloride, 0.1% potassium iodide. 0.2% citric acid and 0.2% w/v polyvinylpyrrolidone in a solvent mixture of 80/20 v/v isopropanol/water and dried for 2 minutes at 60° C. to give a dry top coat weight of 0.4 g/m².

Processing of the Plates

In each case, the sample of plate precursor was loaded on to an Agfa Galileo T Platesetter imaging at 1064 nm. The energy required to correctly expose a one pixel checkerboard was determined. The results are shown in Table 2.

TABLE 2

| | Sensitivity |
|---|---|
| Sample | (mJ/cm²) |
| A (Control) | 178 |
| B | 145 |
| C | 149 |
| D | 138 |

### TABLE 2

Following exposure, the top coat was washed off with water and the plate samples were treated with a finishing composition comprising a proteolytic enzyme, an oleophilising agent and a desensitising gum prior to mounting on a printing press. This treatment ensured a good start-up to printing operations with image areas showing high oleophilicity with good ink acceptance, and background non-image areas being clean and free from ink adhesion. The plates all produced 85,000 good quality copies on a Drent Web Offset printing press.

1. A lithographic printing plate precursor comprising:
(a) a grained and anodised aluminium substrate, having provided thereon
(b) a metallic layer, on top of which is applied
(c) a layer comprising at least one sensitising material which adsorbs on to the metallic surface and thereby sensitises the system to heat mode laser exposure.

2. A lithographic printing plate precursor as defined in claim 1 wherein said metallic layer comprises a silver layer.

3. A lithographic printing plate precursor as defined in claim 1 wherein said metallic layer has a thickness of from 1 nm to 100 nm.

4. A lithographic printing plate precursor as defined in claim 1 wherein said sensitising material comprises a material which includes at least one sulphur, selenium or tellurium containing group.

5. A lithographic printing plate precursor as defined in claim 4 wherein said sulphur, selenium or tellurium containing group comprises a thiol, substituted thio, disulphide, thioacid, thioamide or isothiocyanate group, or a selenium and tellurium analogue thereof.

6. A lithographic printing plate precursor as defined in claim 1 wherein said sensitising material comprises a cationic material.

7. A lithographic printing plate precursor as defined in claim 6 wherein said cationic material comprises a cationic surfactant or cationic dye.

8. A lithographic printing plate precursor as defined in claim 1 wherein said sensitising material is present in said layer to the extent of between 5 and 50%.

9. A lithographic printing plate precursor as defined in claim 1 wherein said layer containing at least one sensitising material has, in the absence of other materials, a coating thickness of between a monolayer and 0.5 μm.

10. A lithographic printing plate precursor as defined in claim 1 wherein said layer containing at least one sensitising material comprises at least one other material and has a dry coating weight of between 0.01 and 10 g/m².
